(19) United States
(12) Patent Application Publication
(10) Pub. No.: US 2007/0245708 A1
(43) Pub. Date: Oct. 25, 2007

(54) High cycle fatigue management for gas turbine engines

(75) Inventor: Robert D. Southwick, S. Glastonbury, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/407,474

(22) Filed: Apr. 20, 2006

(51) Int. Cl. F02G 3/00

(52) U.S. Cl. 60/39.091; 60/805

(57) ABSTRACT

A control and method for operating a gas turbine engine senses the operation of blades associated with any number of rotors in the gas turbine engine. If the sensors report to the control that the blades are operating at a speed that can potentially cause damage or undue vibration, the control moves that component to a slightly different speed at which it will not have the potential problem. The control may also change other components to ensure that the thrust provided by the gas turbine engine is maintained relatively constant.

### BACKGROUND OF THE INVENTION

This application relates to a method and a control that monitors the fatigue level of blades at any number of locations within a gas turbine engine, and changes a spool speed should an undesirable amount of fatigue be predicted at a current state of operation. At the same time, while the spool speed is changed, the control attempts to maintain a relatively constant thrust.

Gas turbine engines are provided with a number of functional sections, including a fan section, a compressor section, a combustion section, and a turbine section. Air and fuel are combusted in the combustion section. The fan, compressor and turbine sections include rotors that have blades. The products of the combustion move downstream, and pass over a series of turbine rotors, driving the rotors to create power. In turn, the turbine rotors drive the fan and compressor rotors.

Of course, gas turbine engines operate in a hostile environment. There is a good deal of stress and vibration which tend to be placed onto the blades in the fan, the compressors, and in the turbines. High blade flutter and stress can occur at a very narrow speed range for any one of these components. Flutter and shedding can induce vibration that are of a non-integral order, and can result in high blade stress and potential damage in a very short time. Resonance stress is an integral-order vibration and can also result in high blade stress and potential damage in a relatively short time.

As is known, gas turbine engines typically have a low speed spool which incorporates a low pressure turbine and a shaft that drives a fan and perhaps a low pressure compressor. A high speed spool includes a high pressure turbine and a shaft driving the high pressure compressor. The speeds that can cause potential damage to the blades in the low spool and the high spool may differ.

Fan blade health sensors have been developed to record data only. These fan blade health sensors can operate on eddy currents, microwaves, or in some other fashion. However, these sensors have not been incorporated into a control which takes any corrective action should the potential for upcoming stress and damage be identified.

### SUMMARY OF THE INVENTION

In a disclosed embodiment of this invention, blade health sensors monitor the potential for high stress and potential damage in blades at various locations within a gas turbine engine. Among the potential locations are the blades in the fan, the blades in an optional low pressure compressor (if included), and the blades in a low pressure turbine. Together, these three components are connected to rotate together on a shaft, with the low pressure turbine driving the fan and low pressure compressor. These combined rotating elements are known as the low spool. Similarly, blade health sensors may monitor the operation of a high pressure turbine blade, and the blades in a high pressure compressor. These components are also connected to rotate together by a common shaft. These combined rotating components are known as the high spool.

The blade health sensors can be eddy current, microwave, or any other type sensor. The microwave sensors are currently being developed to best withstand higher temperature locations, such as in the turbine section. At least in some embodiments, such sensors may look for blade flutter, or vibrations. Either of these might be an indication that a blade is experiencing, or approaching, a high stress operation moment.

If potential damage is sensed with regard to the low spool, the speed of the low spool is changed by a controller for the gas turbine engine such that it moves out of the potentially dangerous range. The speed may be changed by adjusting the amount of fuel delivered to the engine, or may be changed in some other fashion such as by adjusting the geometry of a variable vane. In this manner, the speed can be changed, with the vane geometry adjusted to maintain a standard engine thrust. Also, the throat area of a discharge nozzle can be modified to change the speed. The same control occurs in parallel on the high spool.

As mentioned above, the potential damage range can be a very narrow speed range. Thus, only slight changes in speed may be necessary. The control may simply change the speed in either an increasing or decreasing direction until the blade health sensors provide feedback that the blades are no longer facing potential damage.

To maintain a relatively constant thrust, the vanes may be changed, and/or the nozzle throat area may be modified. The control algorithms necessary to maintain a particular thrust by varying these components are known. Also, algorithms are known for separately controlling the speed of the low spool and the high spool. It is the application of such changes to the current invention that is inventive.

These and other features of the present invention can be best understood from the following specification and drawings, the following of which is a brief description.

### BRIEF DESCRIPTION OF THE DRAWINGS

FIG. 1 is a schematic view of a gas turbine engine incorporating the present invention.

FIG. 2 is a flow chart of the present invention.

### DETAILED DESCRIPTION OF THE PREFERRED EMBODIMENT

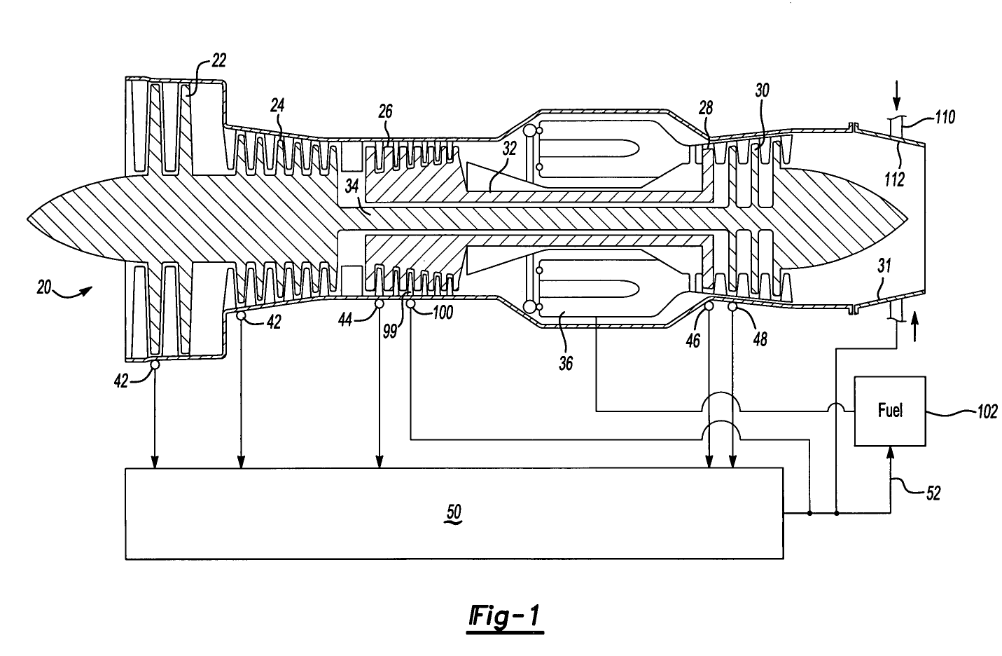

A gas turbine engine 20 is illustrated in FIG. 1. As known, a fan 22 delivers air downstream to a low pressure compressor 24, and a high pressure compressor 26. A high pressure turbine 28 is positioned downstream of a combustion section 36. As known, the fan and compressors deliver compressed air to the combustion section 36, and the air is mixed with fuel to be combusted. The products of combustion move downstream over the high pressure turbine 28, and the low pressure turbine 30. The products of combustion then leave the engine through a nozzle 31. As known, the high pressure turbine 28 is connected by a shaft 32 to the high pressure compressor 26, and drives the high pressure compressor 26. These three components (28, 32 and 26) are known as a “high spool” and tend to rotate at a relatively high speed.

A low pressure turbine 30 is positioned downstream of the high pressure turbine 28. It is connected by a shaft 34 to the low pressure compressor 24, and a fan 22. These components (30, 34, 24 and 22) are known as a “low spool.”

In the present invention, blade health sensors 42 are associated with the blades in fan 22 and low pressure compressor 24 blades. While the blades are not shown as separate parts, as known, each of the sections 22, 24, 26, 28 and 30 are rotors provided with a plurality of discrete and removable blades. The sensors sense the health of these blades, and are utilized to identify any potential concerns with regard to the vibration and stress applied to the blades at the speed of operation of the blades.

Similar sensors 44, 46 and 48 are associated with the high pressure compressor 26, high pressure turbine 28, and low pressure turbine 30, respectively. All of these sensors report back to an engine control 50. The engine control 50 senses the feedback provided by the sensors 42, 44, 46 and 48, and identifies when any of the sensors report that the blades are operating in a manner that could cause upcoming concern from stress or vibration. A signal 52 is sent from the control 50 when such an occurrence is identified. This signal 52 controls the amount of fuel from a fuel supply 102 delivered to the combustion section 36 to change speed of operation of either the low spool or the high spool. Other methods of changing the gas turbine engine such as changing the throat area of the nozzle 31 by a mechanism 110 with an adjustable throat area 112 may be utilized. Moreover, although shown schematically, the vanes 99 associated with any of the rotor sections 22, 24, 26, 28 and 30 may be varied in their geometry such as through a variable vane geometry mechanism 100. Mechanisms 100 and 110 are well known in the art, and are shown in an extremely schematic view in this drawing. However, a worker of ordinary skill in the art would recognize what is being disclosed in this application.

The sensors 42, 44, 46 and 48 may monitor flutter, or vibration, or some other aspect of the operation of the blades to determine when a potential high stress or high vibration occurrence may be approaching. The sensors may be as known, and the indication of high stress may also be as known in the art. It is the control step of responding to such an identified problem by changing the speed of an associated spool that is inventive here. At the same time, the control attempts to minimize any effect on thrust due to the change in the spool speed. The fuel flow, the variable vane geometry and the size of the nozzle opening can all be controlled to change the speed of either the low spool or the high spool to move it a slight amount either increasing or decreasing, and to move outside of the potential danger range. At the same time, the thrust delivered outwardly of the nozzle 31 can be maintained relatively constant even given the speed change by changing the geometry of the vanes by mechanism 100, and/or the nozzle with the nozzle adjustment mechanism 110.

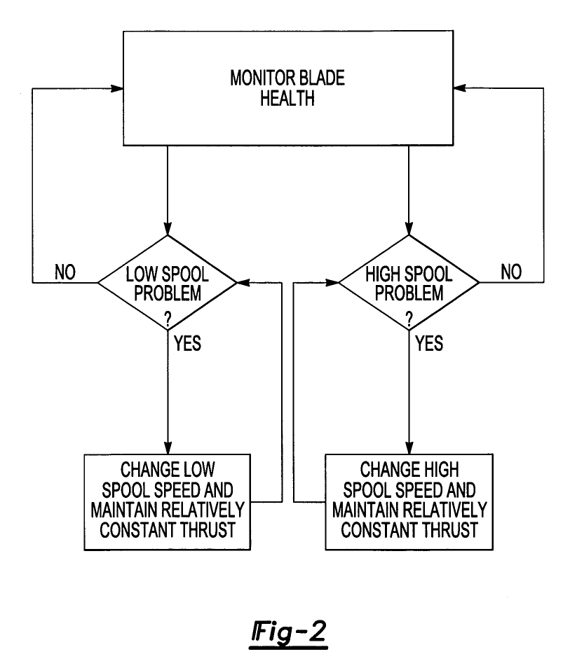

FIG. 2 is a flow chart showing how the control would operate in this invention. If a potential problem is identified with the low spool, the speed of the low spool is changed. Again, in disclosed embodiments, the control may also maintain a constant thrust. On the other hand, if the speed of the high spool is seen as potentially being a problem, the high spool speed is changed. At the same time, aspects of the control to maintain the speed of the other spool, and to maintain constant thrust might also be occurring. The algorithms necessary to change the speed of one spool without changing the speed of the other, and the algorithms to maintain constant thrust are known in the art. Also, it should be understood that it may be a very narrow speed that provides the potential problem, and thus large changes in speed need not occur. Thus, the change as identified in this method, and in the FIG. 2 flowchart, may be very small step changes in the speed.

The present invention thus achieves a simple method and control for ensuring that a gas turbine engine is not operated at a speed range that could prove problematic. Given the relatively short period of time that is required for operation in a problematic speed range to cause damage, the present invention is thus extremely valuable in avoiding such a speed range.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A gas turbine engine comprising:
a fan section, a compressor section, a combustion section and a turbine section, said turbine section including at least one turbine rotor having blades, said fan section including at least one fan rotor having blades, and said compressor section including at least one compressor rotor having blades;
a blade health sensor monitor associated with the blades in at least one monitored rotor in at least one of said fan section, said compressor section and said turbine section, said blade health sensor providing feedback of the health of said monitored blades to a control, and said control identifying a potential problem operating speed for said monitored blades based on said feedback, and changing a speed of said at least one monitored rotor based upon said feedback if a problem speed is identified.

2. The gas turbine engine as set forth in claim 1, wherein said control also controlling the engine to attempt to maintain constant thrust while changing said speed.

3. The gas turbine engine as set forth in claim 1, wherein said turbine section includes at least two turbine rotors with a high pressure turbine rotor and a low pressure turbine rotor, and said high pressure turbine rotor driving said compressor rotor, and said low pressure turbine section driving said fan rotor.

4. The gas turbine engine as set forth in claim 3, wherein said low pressure turbine also driving a low pressure compressor rotor.

5. The gas turbine engine as set forth in claim 3, wherein said blade health sensor includes plural blade health sensors with at least one associated with said fan rotor, said high pressure compressor rotor, and each of said low and high pressure turbine rotors.

6. The gas turbine engine as set forth in claim 5, wherein a speed of said fan rotor and said low pressure turbine rotor is changed should a potential problem be identified with regard to a speed of operation of either said fan rotor and said low pressure turbine rotor.

7. The gas turbine engine as set forth in claim 6, wherein the speed of said high pressure turbine rotor and said high pressure compressor rotor is changed should a potential problem be identified with regard to a speed of operation of either said high pressure compressor rotor and said high pressure turbine.

8. The gas turbine engine as set forth in claim 3, wherein a fuel level delivered to said combustion section is changed by said control to change the speed.

9. The gas turbine engine as set forth in claim 8, wherein the speed of operation of said gas turbine engine is changed only slightly to move said at least one rotor outside of a problem speed range.

10. The gas turbine engine as set forth in claim 9, wherein said blade health sensor continues to provide feedback to said control, and said control stops changing said speed once the blade health sensor reports that said monitored blades have left a problem speed.

11. The gas turbine engine as set forth in claim 8, wherein at least one of a variable vane geometry and a variable nozzle throat area is changed when said fuel is changed to maintain operation of said gas turbine engine during the speed change.

12. A method of operating a gas turbine engine including the steps of:
providing a fan section, a compressor section, a combustion section and a turbine section, said turbine section including at least one turbine rotor having blades, said fan section including at least one fan rotor having blades, and said compressor section including at least one compressor rotor having blades;
monitoring the blades in at least one monitored rotor in at least one of said fan section, said compressor section and said turbine section, providing feedback of the health of said monitored blades and identifying a potential problem operating speed for said monitored blades based on said feedback, and changing a speed of said at least one rotor based upon said feedback if a problem speed is identified.

13. The method as set forth in claim 12, and further including the steps of attempting to maintain a relatively constant thrust when changing said speed.

14. The method as set forth in claim 12, wherein said turbine section includes at least two turbine rotors with a high pressure turbine rotor and a low pressure turbine rotor, and said high pressure turbine rotor driving said compressor rotor, and said low pressure turbine section driving said fan rotor.

15. The method as set forth in claim 14, wherein said low pressure turbine driving a low pressure compressor rotor.

16. The method as set forth in claim 14, wherein blades associated with said fan rotor, said high pressure compressor rotor, and each of said low and high pressure turbine rotors are monitored.

17. The method as set forth in claim 16, wherein a speed of said fan rotor and said low pressure turbine rotor is changed should a potential problem be identified with regard to a speed of operation of either said fan rotor and said low pressure turbine rotor.

18. The method as set forth in claim 17, wherein a speed of said high pressure turbine rotor and said high pressure compressor rotor is changed should a potential problem be identified with regard to a speed of operation of either said high pressure compressor rotor and said high pressure turbine.

19. The method as set forth in claim 14, wherein a fuel level delivered to said combustion section is changed to change the speed.

20. The method as set forth in claim 19, wherein the speed of operation of said gas turbine engine is changed only slightly to move said at least one rotor outside of a problem speed range.

21. The method as set forth in claim 20, including the step of continuing to provide feedback, and stopping the changing of the speed once the feedback indicates that said monitored blades have left a problem speed.

22. The method as set forth in claim 19, wherein at least one of a variable vane geometry and a variable nozzle throat area is changed when said fuel is changed to maintain operation of said gas turbine engine during the speed change.
